(19) United States
(12) Patent Application Publication
(10) Pub. No.: US 2024/0125237 A1
(43) Pub. Date: Apr. 18, 2024

(54) INTEGRALLY BLADED ROTOR WITH LEADING EDGE SHIELD

(71) Applicant: Raytheon Technologies Corporation, Farmington, CT (US)

(72) Inventor: David A. Knaul, Glastonbury, CT (US)

(21) Appl. No.: 17/967,361

(22) Filed: Oct. 17, 2022

(51) Int. Cl. F01D 5/14; F01D 5/34

(52) U.S. Cl. CPC F01D 5/147; F01D 5/34; F05D 2230/23; F05D 2240/303

(57) ABSTRACT

An integrally bladed rotor for a gas turbine engine, including: a plurality of blades integrally formed with a hub as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield secured to the leading edge of the blade body.

### BACKGROUND

This disclosure relates to a gas turbine engine, and more particularly an integrally bladed rotor that may be incorporated into a gas turbine engine.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. In some applications, the rotating blades are part of an integrally bladed rotor having a plurality of blades integrally formed with a hub as a single component. Since the blades are formed with a hub as a single component significant damage to one or more of the blades of an integrally bladed rotor may require the whole rotor to be replaced. As such, it is desirable to provide an integrally bladed rotor with a plurality of blades that are able to withstand foreign object damage (FOD) and/or blades that are capable of being repaired without replacing the entire rotor.

### BRIEF DESCRIPTION

Disclosed is an integrally bladed rotor for a gas turbine engine, including: a plurality of blades integrally formed with a hub as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield secured to the leading edge of the blade body.

In addition to one or more of the features described above, or as an alternative to any of the foregoing embodiments, the leading edge shield is formed from one of the following materials: titanium; nickel; and steel alloys.

In addition to one or more of the features described above, or as an alternative to any of the foregoing embodiments, the blade body is formed from one of the following materials: aluminum; titanium; nickel; composite materials; and steel alloys.

In addition to one or more of the features described above, or as an alternative to any of the foregoing embodiments, the blade body is formed from a first material and the leading edge shield is formed from a second material, the first material being the same as the second material.

In addition to one or more of the features described above, or as an alternative to any of the foregoing embodiments, the blade body is formed from a first material and the leading edge shield is formed from a second material, the first material being different from the second material.

In addition to one or more of the features described above, or as an alternative to any of the foregoing embodiments, the leading edge shield is adhesively bonded to the leading edge by an adhesive.

In addition to one or more of the features described above, or as an alternative to any of the foregoing embodiments, the adhesive comprises a material having a melting point that is less than a melting point of the leading edge shield.

In addition to one or more of the features described above, or as an alternative to any of the foregoing embodiments, the leading edge shield is removably secured to the leading edge.

Also disclosed is a gas turbine engine, including: a compressor section; a combustor fluidly connected to the compressor section; a turbine section fluidly connected to the combustor, the compressor section including: a high pressure compressor and a low pressure compressor, at least one of the high pressure compressor and the low pressure compressor including: an integrally bladed rotor for a gas turbine engine, the integrally bladed rotor including: a plurality of blades integrally formed with a hub as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield secured to the leading edge of the blade body.

In addition to one or more of the features described above, or as an alternative to any of the foregoing embodiments, the leading edge shield is formed from one of the following materials: titanium; nickel; and steel alloys.

In addition to one or more of the features described above, or as an alternative to any of the foregoing embodiments, the blade body is formed from one of the following materials: aluminum; titanium; nickel; composite materials; and steel alloys.

In addition to one or more of the features described above, or as an alternative to any of the foregoing embodiments, the blade body is formed from a first material and the leading edge shield is formed from a second material, the first material being the same as the second material.

In addition to one or more of the features described above, or as an alternative to any of the foregoing embodiments, the blade body is formed from a first material and the leading edge shield is formed from a second material, the first material being different from the second material.

In addition to one or more of the features described above, or as an alternative to any of the foregoing embodiments, the leading edge shield is adhesively bonded to the leading edge by an adhesive.

In addition to one or more of the features described above, or as an alternative to any of the foregoing embodiments, the adhesive comprises a material having a melting point that is less than a melting point of the leading edge shield.

Also disclosed is a method of manufacturing an integrally bladed rotor of a gas turbine engine, including: forming a plurality of blades integrally with a hub to provide the integrally bladed rotor as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield removably secured to the leading edge of the blade body by an adhesive.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine in accordance with this disclosure;

FIG. 2 is a perspective view of an integrally bladed rotor in accordance with the present disclosure;

FIG. 3 is a perspective view of an integrally bladed rotor with a leading edge shield in accordance with the present disclosure; and

FIG. 4 is a perspective view of an integrally bladed rotor with a leading edge shield in accordance with the present disclosure.

### DETAILED DESCRIPTION

A detailed description of one or more embodiments of the disclosed apparatus and method are presented herein by way of exemplification and not limitation with reference to the FIGS.

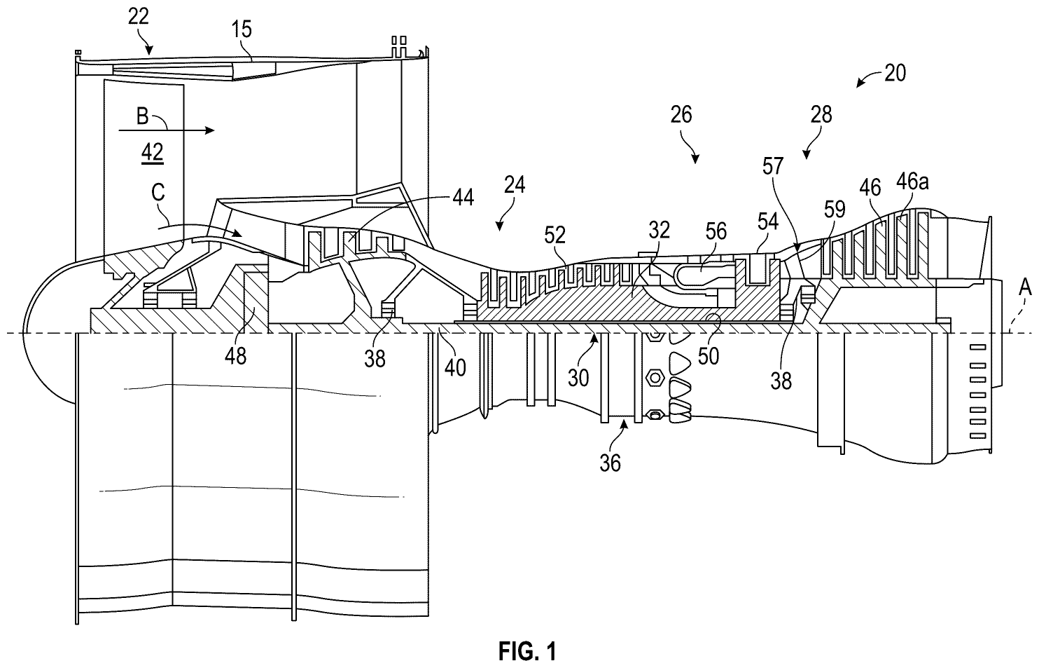

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first or low pressure compressor 44 and a first or low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second or high pressure compressor 52 and a second or high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (“TSFC”)”—is the industry standard parameter of pound-mass (lbm) of fuel per hour being burned divided by pound-force (lbf) of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

In one non-limiting example, the fan 42 includes less than about 26 fan blades. In another non-limiting embodiment, the fan 42 includes less than about 20 fan blades. Moreover, in one further embodiment the low pressure turbine 46 includes no more than about 6 turbine rotors schematically indicated at 46a. In a further non-limiting example the low pressure turbine 46 includes about 3 turbine rotors. A ratio between the number of blades of the fan 42 and the number of low pressure turbine rotors 46a is between about 3.3 and about 8.6. The example low pressure turbine 46 provides the driving power to rotate the fan section 22 and therefore the relationship between the number of turbine rotors 46a in the low pressure turbine 46 and the number of blades in the fan section 22 discloses an example gas turbine engine 20 with increased power transfer efficiency.

While a geared turbofan engine is described above. Various embodiments of the present disclosure may be used with any type of engines for example, non-geared turbofan engines, turbojet engines, turboprop engines and afterburning turbojet engines.

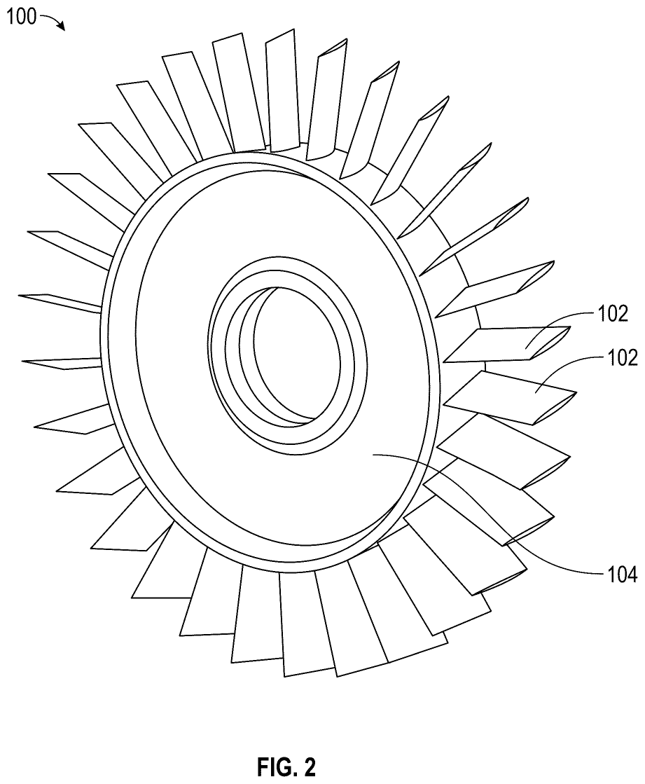

FIG. 2 illustrates an integrally bladed rotor 100. The integrally bladed rotor 100 can be used in the low pressure compressor 44 and/or the high pressure compressor 52. The integrally bladed rotor has a plurality of blades 102 integrally formed with a hub 104 as a single component. Referring now to FIGS. 2-4, each of the plurality of blades 102 has a blade body or airfoil body 106 extending from the hub 104 to an opposed blade tip surface 108 along a longitudinal axis. The blade body 106 has a pressure side 110 and a suction side 112 each extending between a leading edge or upstream edge 114 and a trailing edge or downstream edge 116. The upstream edge and the downstream edge are relative to the gas flow path B (FIG. 1).

As is known in the related arts, each of the plurality of blades 102 are integrally formed with the hub 104 as a single component such that the blades 102 cannot be removed from the hub 104. The formation of the blades 102 with the hub 104 may be achieved in any suitable fashion such as including but not limited to welding, casting, combinations of welding and casting or any other suitable manufacturing process.

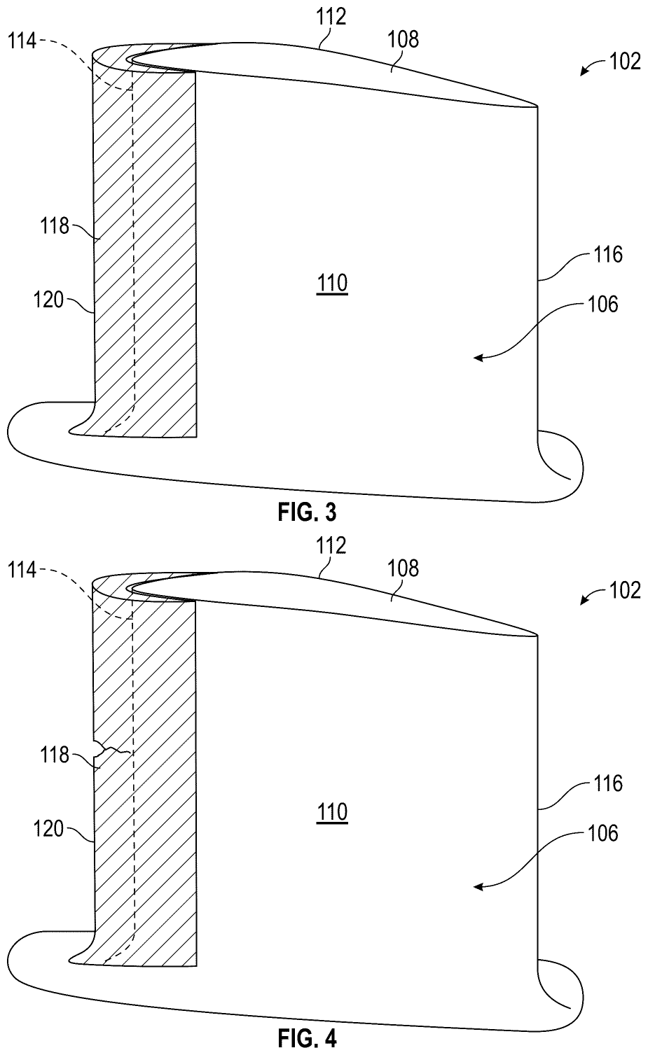

Referring now to at least FIG. 3 one of the plurality of blades 102 of the integrally bladed rotor 100 in accordance with the present disclosure is illustrated. Here the each of the plurality of blades is provided with a leading edge shield or sheath 118 in accordance with the present disclosure. The leading edge shield or sheath 118 is secured to the leading edge or upstream edge 114 of the blade body 106. In embodiment, the leading edge shield or sheath 118 is adhesively bonded to the leading edge or upstream edge 114 of the blade body 106. By securing the leading edge shield or sheath 118 the leading edge or upstream edge 114 of the blade body 106 several advantages are achieved. The leading edge of the blade body can now be replaced when damaged without having to replace the entire rotor or attempt to weld a repair on a portion of the damaged blade body. See for example, FIG. 4 which illustrates a portion of the leading edge shield or sheath 118 being damaged. As illustrated, only the leading edge shield or sheath 118 is damaged and the blade body 106 remains undamaged. As such, the leading edge shield or sheath 118 can be removed and replaced with another undamaged leading edge shield or sheath 118. This allows for repair of the blades without replacing the entire rotor.

Still further and since the leading edge shield or sheath 118 is replaceable several additional advantages are provided. For example, a forward end 120 of the leading edge shield or sheath 118 may be thinner to allow for improved aerodynamics without having to be concerned with being too thin for damage from foreign objects since the leading edge shield or sheath 118 is now replaceable.

In addition, the adhesives used for securing the leading edge shield or sheath 118 to the blade body may have a melting point that is less than that of the blade body and the leading edge shield or sheath 118. As such, the integrally bladed rotor 100 can be subjected to temperatures that will cause the adhesive securing the leading edge shield or sheath 118 to the blade body 106 to dissolve thus allowing the damaged leading edge shield or sheath 118 to be removed by a heating process that will not damage or change the properties of the blade body 106. For example and in one non-limiting embodiment, the adhesive is an epoxy. Alternatively, the adhesive may be a polyimide.

For example, the leading edge shield or sheath 118 may be formed from any one of titanium, nickel and steel alloys which makes it more resistant to foreign objects. In addition, the blade body may also be formed from any one of titanium, nickel, aluminum, composite materials (e.g., an organic resin matrix composite with carbon fiber reinforcement) and steel alloys. In one embodiment, the leading edge shield or sheath 118 may be formed from the same material as the blade body. Alternatively, the blade body may be formed from a different material than the leading edge shield or sheath 118. Also and by forming the leading edge shield or sheath 118 and the blade body from these materials, they are capable of being heated to a point where the adhesive securing the leading edge shield or sheath 118 to the blade body is degraded to the point where the leading edge shield or sheath 118 can be removed from the blade body without damaging the structural properties of the blade body and/or the leading edge shield or sheath 118. For example and in one embodiment, the damaged leading edge shield or sheath 118 may be removed, repaired and then replaced or alternatively the damaged leading edge shield or sheath 118 is removed and replaced with a new or undamaged leading edge shield or sheath 118.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. An integrally bladed rotor for a gas turbine engine, comprising:
a plurality of blades integrally formed with a hub as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield secured to the leading edge of the blade body.

2. The integrally bladed rotor as in claim 1, wherein the leading edge shield is adhesively bonded to the leading edge by an adhesive.

3. The integrally bladed rotor as in claim 2, wherein the adhesive comprises a material having a melting point that is less than a melting point of the leading edge shield.

4. The integrally bladed rotor as in claim 1, wherein the leading edge shield is formed from one of the following materials: titanium; nickel; and steel alloys.

5. The integrally bladed rotor as in claim 4, wherein the blade body is formed from one of the following materials: aluminum; titanium; nickel; composite materials; and steel alloys.

6. The integrally bladed rotor as in claim 5, wherein the blade body is formed from titanium and the leading edge shield is formed from titanium, wherein the leading edge is formed by an intersection of the pressure side and the suction side of the blade body.

7. The integrally bladed rotor as in claim 5, wherein the blade body is formed from a first material and the leading edge shield is formed from a second material, the first material being different from the second material.

8. The integrally bladed rotor as in claim 6, wherein the leading edge shield is adhesively bonded to the leading edge by an adhesive.

9. The integrally bladed rotor as in claim 8, wherein the adhesive comprises a material having a melting point that is less than a melting point of the leading edge shield.

10. The integrally bladed rotor as in claim 1, wherein the leading edge shield is removably secured to the leading edge.

11. A gas turbine engine, comprising:
a compressor section;
a combustor fluidly connected to the compressor section;
a turbine section fluidly connected to the combustor, the compressor section comprising:
a high pressure compressor and a low pressure compressor, at least one of the high pressure compressor and the low pressure compressor including:
an integrally bladed rotor for a gas turbine engine, the integrally bladed rotor comprising:
a plurality of blades integrally formed with a hub as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield secured to the leading edge of the blade body.

12. The gas turbine engine as in claim 11, wherein the leading edge shield is adhesively bonded to the leading edge by an adhesive.

13. The gas turbine engine as in claim 12, wherein the adhesive comprises a material having a melting point that is less than a melting point of the leading edge shield.

14. The gas turbine engine as in claim 11, wherein the leading edge shield is formed from one of the following materials: titanium; nickel; and steel alloys.

15. The gas turbine engine as in claim 14, wherein the blade body is formed from one of the following materials: aluminum; titanium; nickel; composite materials; and steel alloys.

16. The gas turbine engine as in claim 15, wherein the blade body is formed from titanium and the leading edge shield is formed from titanium, wherein the leading edge is formed by an intersection of the pressure side and the suction side of the blade body.

17. The gas turbine engine as in claim 15, wherein the blade body is formed from a first material and the leading edge shield is formed from a second material, the first material being different from the second material.

18. The gas turbine engine as in claim 16, wherein the leading edge shield is adhesively bonded to the leading edge by an adhesive.

19. The gas turbine engine as in claim 18, wherein the adhesive comprises a material having a melting point that is less than a melting point of the leading edge shield.

20. A method of manufacturing an integrally bladed rotor of a gas turbine engine, comprising:
forming a plurality of blades integrally with a hub to provide the integrally bladed rotor as a single component, each of the plurality of blades having a blade body extending from the hub to an opposing blade tip surface along a longitudinal axis, each blade body having a pressure side and a suction side each extending between a leading edge and a trailing edge of the blade body; and each of the plurality of blades including a leading edge shield removably secured to the leading edge of the blade body by an adhesive.
